(19) United States
(12) Patent Application Publication
(10) Pub. No.: US 2003/0011682 A1
(43) Pub. Date: Jan. 16, 2003

(54) Method of sending digital photographs

(76) Inventors: Abigail Jane Sellen, Newbury (GB); Andrew Dudley Morgan, Bristol (GB)

Correspondence Address: HEWLETT-PACKARD COMPANY, Intellectual Property Administration, P.O. Box 272400, Fort Collins, CO, 80527-2400, US

(21) Appl. No.: 10/191,433

(22) Filed: Jul. 10, 2002

(30) Foreign Application Priority Data
Jul. 10, 2001 (GB) 0116862.4

(51) Int. Cl. H04N 5/225; H04N 5/232; H04N 11/00

(52) U.S. Cl. 348/207.1; 348/211.1; 348/207.2; 348/552

(57) ABSTRACT

A method of specifying the delivery of a digital photograph from a digital camera via a digital communications network provided with delivery means, the digital camera having a processor communicatively connectable to the digital communications network, the method comprising: supplying the processor with a digital photograph; supplying the processor with input to enable delivery coordinates for the digital photograph to be determined; supplying the processor with input specifying a delivery format in which the digital photograph is to be delivered.

This invention relates in general to a method of sending digital photographs.

### BACKGROUND OF THE INVENTION

Recently, digital photography has increased in popularity, and many people now own digital cameras which enable digital photographs to be created and saved.

Often it is necessary to send a digital photograph to another person, to enable them to view it, or when collaborating on a word processed document, for example. Traditionally only those fortunate enough to own or have access to a PC have been able to partake in the sending and receiving of such digital photographs. A typical procedure would be for a user to create a digital photograph with a digital camera and then transfer it onto his computer. He would then send it (often by first attaching it to an e-mail) via a network (e.g. the Internet) to the intended recipient. Alternatively, and more awkwardly, the digital photograph could be transferred by saving it onto a portable data carrier (e.g. a floppy disk) and then passing this data carrier to the recipient. Such a process of passing a data carrier may take a long time if the two users are far apart, since postage or some other kind of manual delivery service would be required.

It is clear that the above procedure has significant shortcomings in that both the sender and the recipient of the digital photograph are required to own or at least have access to a PC, preferably one connected to a digital communications network such as the Internet. However, PCs are not inexpensive, and at the time of writing, only about 30% of the UK population has ready access to a PC. Furthermore, the popularity of digital photography is increasing, and since some digital cameras allow their photographs to be printed without the use of a PC, there exist users of digital cameras who create digital photographs but do not have a PC with which to send them to others.

Even if the creator of a digital photograph has access to a suitable computer from which the photograph could be sent, if the recipient does not have a computer then the options for sending the photograph to them become very limited. The photograph could be printed out and hand delivered to the recipient. However, if a longer distance is involved, then the printout would either need to be sent by post, or perhaps by fax if the intended recipient has a fax machine. (Advantageously it is possible to send a fax from a PC connected to the Internet.) However, if the intended recipient does not have access to a fax machine, then posting would be the only option, which may be particularly slow if the distance between sender and recipient is especially great (e.g. different continents).

The advent of personal data assistants (PDAs) has gone some way in helping to bring the functionality of PCs into the hands of more people. PDAs are very useful for storing the address details of potential recipients (e.g. in a ‘contacts’ database) and enable data files such as word processed documents to be created. Some PDAs have integral or attachable digital cameras and thereby can be used to create digital photographs too. However, even if a user owns a PDA, it is still awkward to send a digital photograph to a recipient, particularly one who does not own a PC, a PDA or a fax machine.

There clearly exists no straightforward means by which a digital photograph may be sent from the user of a digital camera, a PC or a PDA to someone who does not own one of these devices.

It is a general object of the present invention to overcome or at least mitigate the problems identified above.

### SUMMARY OF THE INVENTION

According to a first aspect of the invention there is provided a method of specifying the delivery of a digital photograph from a digital camera via a digital communications network provided with delivery means, the digital camera having a processor communicatively connectable to the digital communications network, the method comprising: supplying the processor with a digital photograph; supplying the processor with input to enable delivery coordinates for the digital photograph to be determined; supplying the processor with input specifying a delivery format in which the digital photograph is to be delivered.

This has the advantage of providing a straightforward means for sending a digital photograph from a first user to a second user, who may not have access to a digital camera, a PC or a PDA. The invention enables immediate functionality to be provided to the first user who requires the digital photograph to be sent, enabling this user to take immediate action such that his requirement will be satisfied. The delivery of the digital photograph to the second user is then made via the digital communications network, with the delivery process either being initiated immediately if a suitable connection to the digital communications network exists, or being deferred until a suitable connection is made. This so-called initiation of the delivery process is the sending of the digital photograph data away from the first user, via the digital communications network, and through to the delivery means with which the digital communications network is provided.

Preferably the delivery means with which the digital communications network is provided are selected from a group comprising: a printer and a postal service, facsimile transmission, electronic mail transmission, display in a digital photo frame. Having the digital photograph printed and posted to the second user enables him to receive it without him being required to own or have access to a digital camera, a PC or a PDA. Using facsimile transmission provides a faster means of sending the digital photograph than using post. Alternatively, if the second user does have access to a computer, then electronic mail transmission can be employed, with its means of execution having been simplified by this invention. As a further alternative, the digital photograph can be sent to a digital photo frame or a functionally comparable device, e.g. using wireless connectivity. A digital photo frame typically comprises an LCD flat panel within a frame, a processor, and means (e.g. a wireless transceiver) by which it can receive digital photograph data for display.

Preferably the delivery coordinates are of a type included within a set of predetermined types.

Preferably the delivery coordinates are selected from a group comprising: a postal address, a fax number, an electronic mail address, a network address; and preferably the delivery format is selected from a group comprising postal delivery, a facsimile transmission, an electronic mail communication, data transmission over the network.

It will be appreciated that the completion of the delivery process depends on the performance of the delivery means. That is to say, delivery to the intended recipient is dependent on the postal delivery service successfully making the delivery, or on the recipient's fax machine or electronic mail facility functioning correctly, for example.

Preferably the method further comprises supplying the processor with text for delivery together with the digital photograph. This text could advantageously be a greeting, a reminder of the reason why the photograph was created, explanatory notes, or any other alphanumeric string the user wishes to be sent to the specified recipient along with the digital photograph.

Preferably the method further comprises providing a database holding an identity of a recipient together with delivery coordinates pertaining to the said recipient, supplying the processor with the identity of the recipient and operating the processor to retrieve the delivery coordinates of the recipient from the database. This has the advantage of enabling the first user to simply supply the name (or a nickname) of the intended recipient (the second user), and the processor will then retrieve the appropriate delivery coordinates pertaining to the second user, such as his postal address, fax number or e-mail address and, as outlined above, will use the appropriate delivery destination according to the delivery format specified by the first user.

Preferably the method further comprises the processor determining delivery means in accordance with the delivery coordinates associated with the said recipient on the database. The processor may be configured to offer a plurality of delivery means to the user for selection, the delivery means being in accordance with the delivery coordinates associated with the said recipient on the database.

As well as digital cameras themselves, the present invention is intended to be applicable to any device having a digital camera, such as a personal computer, a PDA or a mobile station (e.g. a mobile phone).

Advantageously the processor selects the appropriate delivery coordinates (e.g. the postal address or fax number) of the specified recipient according to the specified delivery format (e.g. a postal delivery or a facsimile transmission). For example, if the first user specifies that the photograph is to be delivered in the form of a postal delivery to the second user, the processor selects the second user's postal address as the appropriate delivery destination.

According to a second aspect of the invention there is provided a computer program to enable the sending of a digital photograph from a digital camera, the digital camera having a processor communicatively connectable to a digital communications network, the program being executable to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

Preferably the delivery format specified is selected from a group comprising: postal delivery, facsimile transmission, electronic mail communication, data transmission over the network, and preferably the delivery coordinates determined are selected from a group comprising: a postal address, a fax number, an electronic mail address, a network address.

Preferably the computer program is configured to cause the processor to access a database in which is stored an identity of a recipient together with delivery coordinates pertaining to the recipient, the program thereby enabling the processor to retrieve, from the database, the delivery coordinates pertaining to the recipient on receiving input comprising the said identity of the recipient.

According to a third aspect of the invention there is provided a computer program stored on a data carrier to enable the sending of a digital photograph from a digital camera, the digital camera having a processor communicatively connectable to a digital communications network, the program being executable to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

According to a fourth aspect of the invention there is provided a computer program executing on the processor of a digital camera, the processor being communicatively connectable to a digital communications network, the program being arranged to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

According to a fifth aspect of the invention there is provided a computer program executing on a processor on a server connected to a digital communications network to enable the sending of a digital photograph from a digital camera, the program being arranged to enable the processor to receive a digital photograph, to receive input to enable the processor to determine delivery coordinates, to receive input specifying the delivery format in which the digital photograph is to be delivered, and to cause the delivery of the content of the digital data file to delivery means via the digital communications network. Running the program on a server connected to a digital communications network (e.g. on a webserver on the Internet) provides the advantage that the method of the present invention may be run by a third party remote from the first and second users.

### BRIEF DESCRIPTION OF THE DRAWINGS

Embodiments of the invention will now be described, by way of example, and with reference to the drawings in which:

FIG. 1 is an illustrative screenshot generated by a processor operating the method of the invention; and

FIG. 2 is a schematic diagram of a network to which are connected means for sending digital image file content to a selected recipient.

### DETAILED DESCRIPTION OF THE PREFERRED EMBODIMENTS

A method in accordance with the present invention enables a first user to send one or more selected digital photographs from a digital camera to a chosen second user. The first user may supply instructions to the processor of his digital camera either directly or indirectly. Direct control of the processor is possible by the user operating the camera's user interface. Indirect control is possible by the user taking action using a personal computer (PC), personal data assistant (PDA) or a mobile station (e.g. a mobile telephone) communicatively connected to the processor of the digital camera. With indirect control the user supplies instructions to the camera's processor via the user interface of the control device (e.g. the PC), and by viewing the control device's display output (e.g. the monitor of the PC).

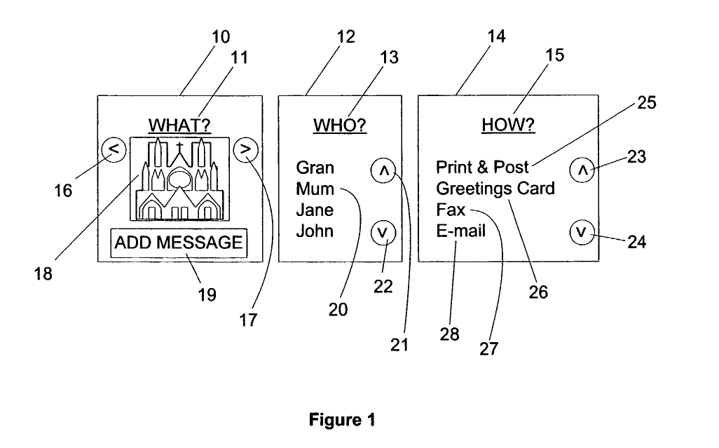

As illustrated in FIG. 1, the sending of a selected digital photograph is achieved by supplying three pieces of information to the processor of the camera and establishing a connection between the camera and a data communication network. The three pieces of information, which may be supplied in any order, are illustrated graphically on the display of the device as three menus 10, 12, 14 which correspond respectively to:

what digital photograph is to be sent (i.e. “What (11) is to be sent?”);

to whom the selected digital photograph is to be sent (i.e. “Who (13) is to be the recipient?”); and

the format in which the digital photograph is to be sent to the intended recipient (i.e. “How (15) to send it?”).

These three menus may appear as boxes (as shown in FIG. 1), or in a pull-down menu format, or in an alternative menu format as are known to those skilled in the art.

The first menu 10 displays a digital photograph 18, and selection means are provided to enable the user to select, from a predetermined directory, the digital photograph to be sent to the second user. The selected digital photograph appears before the user. As shown in the Figure, the selection means may comprise two icons 16,17 which can be activated by clicking using a mouse on a PC, or by touching with a stylus on a touch-sensitive PDA screen. By selecting the ‘next’ icon 17 the selection advances to the next photograph data file in the directory, whilst by selecting the ‘previous’ icon 16 the selection goes back to the previous file in the directory. Methods of using icons to enable files to be selected are well known in the fields of computing and user interface engineering.

In the preferred embodiment of FIG. 1, the user is also provided with an option 19 to add a message to accompany the photograph to be sent. This message may be explanatory text (e.g. details of the photograph) or may be a greeting. In the latter case this enables the provision of a straightforward way to compose and send greetings cards. The provision of this ‘Add Message’ option 19 contributes valuable functionality to a digital camera. Many digital camera users have a reason for taking a particular photograph, and may have an accompanying message or phrase and an intended recipient (and quite possibly a delivery format) in mind at the time of taking the picture. By using the present invention immediately after taking the photograph, the user can ensure that he does not forget to whom the picture should be sent, and by utilising the ‘Add Message’ feature 19 he is able to add his accompanying text straight away, before he could have a chance to forget.

The user is required to select the identity of the person to whom it is wished that the digital photograph be sent. Accordingly the second menu 12 provides a list 20 of the names of possible recipients from which the user can make a selection. The user can select the desired recipient by clicking on the appropriate name. Icons 21,22 are provided to enable the user to scroll through names if there are more names in the list than can be displayed at any one time.

The user is also required to select the format in which the chosen digital photograph is to be sent to the chosen recipient. A series of options 25-28 are displayed in the third menu 14, from which the user can make a choice. Common options are:

to print the chosen digital photograph and to send it to the intended recipient by post (25);

to print the chosen digital photograph on the cover of a greetings card and to print a message (as supplied using the ‘Add Message’ facility 19 described above) inside the card (26);

to send the chosen digital photograph by fax (27); and to send the chosen digital photograph by e-mail (28).

Again, icons 23,24 are provided to enable the user to scroll through the delivery options if there are more options in the list than can be displayed at any one time.

Upon selecting the delivery format 25-28 the digital photograph can then be sent, although, prior to dispatch, the user may be shown a dialogue box inviting him to confirm the photograph to be sent, the intended recipient and the delivery format. The delivery of the digital photograph to the second user is then made via a digital communications network such as the Internet, with the delivery either being initiated immediately if a suitable connection to the digital communications network exists, or being deferred until a suitable connection is made.

It will be appreciated that file transfer between digital cameras and devices such as PCs and PDAs is readily possible, using manual means (e.g. physically transporting a data carrier such as a solid state memory module from one device to another), via an electrical connection (e.g. a USB or a serial cable), or using wireless means such as Bluetooth (RTM) or infra-red transmission. Because of its fast data transfer rate, Bluetooth (RTM) transmission is particularly suited to image file transfer.

Accordingly, image file content created on a digital camera may be dispatched from a PC or a PDA, via the Internet or another network, in accordance with the present invention. Alternatively the image file content may be sent directly from the digital camera if the camera is equipped with suitable connectivity features (e.g. a network interface or modem) and is connected to the appropriate network. This connection could be made by cable or via a Bluetooth (RTM) link, either of which could potentially be made via a mobile phone equipped with a Bluetooth (RTM) transceiver. Mobile phones with built-in digital cameras are also envisaged, and in such a case the photograph would be sent directly from the phone to the Internet.

Enabling the method of the present invention to be used with a digital camera provides for an elegant service in which a user takes a digital photograph, adds accompanying text as desired, identifies a recipient, and informs the processor of the format in which the photograph (and accompanying text) is to be sent to the recipient. The photograph is then dispatched accordingly.

The three menus 10,12,14 will now be explained in more detail:

Photo-graph Selection Menu 10

The digital photographs presented to the user are digital image files, which may have been (but not necessarily) captured using the user's own digital camera. The photographs from which the user can make his selection are stored in a database or another file store of some kind. The image files may be held in the camera's memory. However, a database of digital photographs may be used that is not located in the camera itself. For example, if the method in accordance with the invention is operated using a PC the database may be on one of the PC's local file storage media (e.g. the hard disk), or alternatively may be on a remote file store such as a network server or a webserver. If the method is operated using a PDA the photographs may be held locally (e.g. on a solid state memory module inserted in the PDA) or on a device connected to the PDA such as a digital camera, or alternatively may be on a remote file store such as a webserver. If the device being used is a mobile telephone the files are more likely to be held remotely from the phone, e.g. on a webserver accessible from the phone via the Internet. However, if the device is a mobile phone with a built-in camera then the photographs would be more likely to be stored locally in the device's memory.

Recipient Selection Menu 12

The list of recipients 20 is preferably drawn from a ‘contacts’ database local to the electronic device (e.g. PC) being used to input instructions, or alternatively on a remote database such as a webserver. It is envisaged that a common way by which a user would use the present method, e.g. using a PDA, would be for him to select a digital photograph from a web-based database and then to choose a recipient from his local contacts database. However, it will be appreciated that the contacts database may be also be on the remote server.

As illustrated in FIG. 1, preferably only a list of names 20 are displayed in the menu 12. The database of names is pre-prepared with the postal address and/or fax number and/or e-mail address associated with each name in the list. This thereby provides a straightforward facility for the user to use: The user only needs inform the processor of the name of the intended recipient, and the software draws upon the database to avail itself of the associated postal address and/or fax number and/or e-mail address.

If the user's contacts database is held on a remote webserver it is envisaged that the provider of the webserver will arrange for the contacts details to be periodically updated from the user. Alternatively the content of such a database could be verified with reference to other (third party) databases such as those containing telephone directory information or the electoral register.

Delivery Format Selection Menu 14

This menu is intended to be contextual, such that it only presents options if the relevant delivery coordinates (e.g. the intended recipient's postal address, fax number or e-mail address) are known to the database being used.

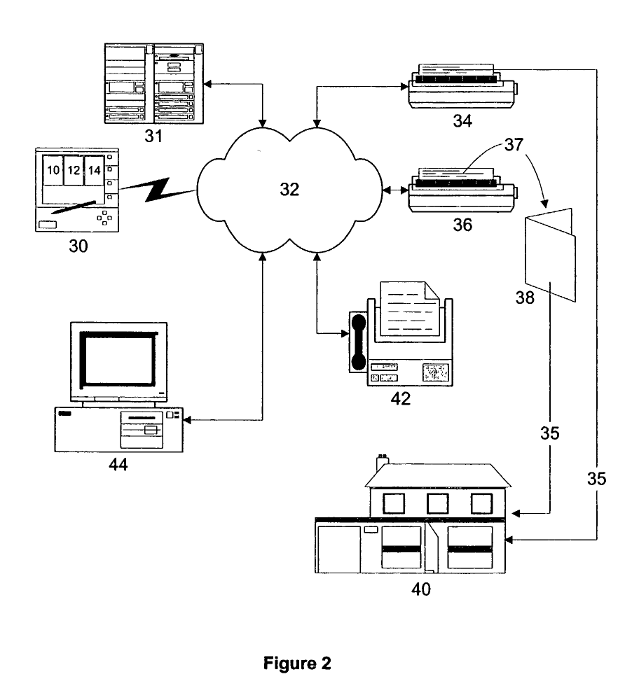

As shown in FIG. 2, the method causes delivery means to be employed that are appropriate to the delivery format 25-28 selected by the user. Say, for example, the user is using a PDA 30 connected to the Internet 32 to control the sending of pictures from his digital camera. The user has used menus 10 and 12 of the PDA to instruct the camera's processor which digital photograph he wishes to send, and the identity of the desired recipient. If, in menu 14, the user now selects ‘Print & Post’ 25 the processor causes the selected digital photograph to be sent, via the Internet 32, to a printer 34. Since a delivery format has been selected which requires knowledge of the recipient's postal address, this address is extracted from the contacts database of the PDA 30 (or alternatively from a web-based database held on a webserver 31) and is also sent to the printer 34. The photograph and an address label are printed by the printer 34 and are then dispatched, by the local postal delivery service 35, to the residence 40 of the intended recipient.

If the user selects ‘Greetings Card’ 26 then the processor causes the photograph to be printed 37 by a printer 36 configured to print the appropriate image and message onto a greetings card 38. An address label is printed using the recipient's address taken from the contacts database. The greetings card 38 is then delivered by the local postal delivery service 35 to the recipient's residence 40. Other specialised print options which could be supported by this invention could include the printing of T-shirts, jigsaw puzzles, coasters and calendars, for example. These options would be presented in menu 14, and a suitable printer would be used instead of the greetings card printer 36.

Alternatively, if ‘Fax’ 27 is selected, the processor causes the image file content to be sent to the recipient's fax machine 42. Because ‘Fax’ 27 has been selected, the processor extracts the appropriate fax number from the contacts database, thereby enabling the digital photograph to be delivered to the recipient by facsimile transmission. If necessary, the digital photograph is first digitally re-rendered by image processing software such that it is sent to the recipient's fax machine 42 in dithered rendering, thereby improving the clarity of the image printed by the fax machine 42.

If the user selects ‘E-mail’ 28 then the processor retrieves the recipient's e-mail address from the contacts database and sends the digital image file (typically in its original format) via the Internet 32 to the recipient's e-mail address. The recipient may then view this file using his PC 44.

A further possible option is for the user to choose to send the digital photograph from the camera to a digital photo frame or a functionally comparable device, e.g. using wireless connectivity. A digital photo frame typically comprises an LCD flat panel within a frame, a processor, and means (e.g. a wireless transceiver) by which it can receive digital photograph data for display. The network address of the digital photo frame, or an equivalent means by which it can be identified by the camera, would need to be supplied to the camera.

Web-based Service

A method in accordance with the present invention is well suited to being run by a third party via the Internet, who would make a charge to the user in return for providing the selected dispatch service. The sender's digital camera would be connected to the Internet to send the chosen digital photographs. Elsewhere the appropriate printing and dispatch means would also be in communication with the Internet. The third party providing the service could run a plurality of printers in different locations around the world (e.g. one per country), thereby enabling the swift printing and postal delivery of the image file content to the intended recipients. The routing software run by the webserver would send the images to the appropriate printer according to the postal address of the intended recipient.

1. A method of specifying the delivery of a digital photograph from a digital camera via a digital communications network provided with delivery means, the digital camera having a processor communicatively connectable to the digital communications network, the method comprising: supplying the processor with a digital photograph; supplying the processor with input to enable delivery coordinates for the digital photograph to be determined; supplying the processor with input specifying a delivery format in which the digital photograph is to be delivered.

2. A method as claimed in claim 1 wherein the delivery means with which the digital communications network is provided are selected from a group comprising: a printer and a postal service, facsimile transmission, electronic mail transmission, display in a digital photo frame.

3. A method as claimed in claim 1 wherein the delivery coordinates are of a type included within a set of predetermined types.

4. A method as claimed in claim 1 wherein the delivery coordinates are selected from a group comprising: a postal address, a fax number, an electronic mail address, a network address.

5. A method as claimed in claim 1 wherein the delivery format is selected from a group comprising postal delivery, a facsimile transmission, an electronic mail communication, data transmission over the network.

6. A method as claimed in claim 1 further comprising supplying the processor with text for delivery together with the digital photograph.

7. A method as claimed in claim 1 further comprising providing a database holding an identity of a recipient together with delivery coordinates pertaining to the said recipient, supplying the processor with the identity of the recipient and operating the processor to retrieve the delivery coordinates of the recipient from the database.

8. A method as claimed in claim 7 further comprising the processor determining delivery means in accordance with the delivery coordinates associated with the said recipient on the database.

9. A method as claimed in claim 7 further comprising the processor offering a plurality of delivery means to the user for selection, the delivery means being in accordance with the delivery coordinates associated with the said recipient on the database.

10. A computer program to enable the sending of a digital photograph from a digital camera, the digital camera having a processor communicatively connectable to a digital communications network, the program being executable to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

11. A computer program as claimed in claim 10 wherein the delivery format specified is selected from a group comprising: postal delivery, facsimile transmission, electronic mail communication, data transmission over the network.

12. A computer program as claimed in claim 10 wherein the delivery coordinates determined are selected from a group comprising: a postal address, a fax number, an electronic mail address, a network address.

13. A computer program as claimed in claim 10 configured to cause the processor to access a database in which is stored an identity of a recipient together with delivery coordinates pertaining to the recipient, the program thereby enabling the processor to retrieve, from the database, the delivery coordinates pertaining to the recipient on receiving input comprising the said identity of the recipient.

14. A computer program stored on a data carrier to enable the sending of a digital photograph from a digital camera, the digital camera having a processor communicatively connectable to a digital communications network, the program being executable to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

15. A computer program executing on the processor of a digital camera, the processor being communicatively connectable to a digital communications network, the program being arranged to cause the processor to receive a digital photograph, to receive input to enable the processor to determine delivery coordinates, to receive input specifying the delivery format in which the digital photograph is to be delivered, and to cause the delivery of the digital photograph to delivery means via the said digital communications network.

16. A computer program executing on a processor on a server connected to a digital communications network to enable the sending of a digital photograph from a digital camera, the program being arranged to enable the processor to receive a digital photograph, to receive input to enable the processor to determine delivery coordinates, to receive input specifying the delivery format in which the digital photograph is to be delivered, and to cause the delivery of the content of the digital data file to delivery means via the digital communications network.

17. A method of delivering a digital photograph comprising:
receiving the digital photograph from a digital camera, and further receiving delivery coordinates of a type included within a set of predetermined types;
providing the digital photograph in a format appropriate for delivery to delivery co-ordinates of that type; and
sending the digital photograph provided to the delivery coordinates.
